(19) United States
(12) Patent Application Publication
(10) Pub. No.: US 2006/0076803 A1
(43) Pub. Date: Apr. 13, 2006

(54) Arrangement for connecting two elements

(76) Inventor: Wilhelm Kreutzberg, Peine (DE)

Correspondence Address: Robin W. Asher;Clark Hill PLC, Suite 3500, 500 Woodward Avenue, Detroit, MI, 48226-3435, US

(21) Appl. No.: 11/246,988

(22) Filed: Oct. 7, 2005

(30) Foreign Application Priority Data
Oct. 8, 2004 (DE) 102 004 049 096.1

(51) Int. Cl. B60K 37/00

(52) U.S. Cl. 296/203.01

(57) ABSTRACT

An arrangement for connecting two elements, having a first element which has an angled first border region at least along one longitudinal edge, a second element which has an angled second border region at least along one longitudinal edge, wherein, when the two elements are arranged in contact with one another, outer sections of the first border region and of the second border region extend away from one another and essentially in a common plane, and having a connecting element which, when the two elements are arranged in contact with one another, laterally encloses the first border region and the second border region, respectively.

### BACKGROUND OF THE INVENTION

1. Field of the Invention

The invention relates to an arrangement for connecting two elements, in particular for securing a vertical first plate element on a vertical second plate element.

2. Description of the Related Art

Connecting arrangements for securing a plate element or the like on a further plate element are known in diverse embodiments. In the field of motor vehicle engineering, arrangements of this type are known for securing and for aligning add-on parts on a vehicle frame. For example, that way bumper cross members can be secured on the longitudinal members of the vehicle frame. The cross member and the respective longitudinal members of the vehicle have opposite, vertical plates or the like which can be brought into contact with one another. By means of suitable screw connections on these end plates, a cross member can therefore be screwed from the front and from the rear to the longitudinal members of the vehicle.

A disadvantage of such a conventional manner of securing a cross member on a vehicle is the generally restricted accessibility of the securing plates from the front and from the rear. This makes the process of installing the cross member on the longitudinal members of the vehicle difficult and correspondingly renders the installation time-consuming and expensive.

### SUMMARY OF THE INVENTION

Accordingly, the invention is based on the object of structurally simplifying the securing of a cross member on at least one longitudinal member. Particularly, the invention should provide an improved accessibility. Further, the connecting arrangement should allow a non-destructive detachment of the cross member in case the cross member was damaged, e.g. in a car accident.

The arrangement according to the invention for connecting two elements comprises a first element which has an angled first border region along at least one longitudinal edge, a second element which has an angled second border region along at least one longitudinal edge, wherein, when the two elements are arranged in contact with one another, outer sections of the first border region and of the second border region extend away from one another and essentially in a common plane, and a connecting element which, when the two elements are arranged in contact with one another, laterally encloses the first border region and the second border region respectively.

The arrangement according to the invention is suitable in particular for securing a cross member on at least one longitudinal member of a motor vehicle. In this case, the first element may expediently be designed as a plate element which is provided on an end side of the longitudinal member. Correspondingly, the second element may be designed as a plate element which is provided lying opposite the first plate element on the cross member. If the cross member is brought face to face with the longitudinal member in such a manner that the two plate elements are arranged in contact with one another, the connecting element can be pushed onto the first and the second border regions either from below or laterally. As a consequence of the lateral enclosure of the first border region and of the second border region by the connecting element, the first plate element is connected to the second plate element, and the cross member is secured on the longitudinal member, without conventionally known screwing means having to be provided in the direction of the longitudinal axis of the longitudinal members. Since the first element is now secured on the second element solely by means of the connecting element, the required installation time can be shortened as a result and the associated costs reduced.

In an advantageous development of the invention, the first border region and the second border region can be angled such that they face away from the respective other, opposite element. For a particularly simple configuration of the respective border regions, the latter being each angled at right angles with respect to the corresponding element. This configuration of the border regions can readily be obtained at reasonable cost by roller shaping of metallic longitudinal profiles or the like.

In an advantageous development of the invention, the first border region may alternatively be formed essentially in the shape of a U-profile, the central limb of which extends away from the opposite, second element. In this case, the second border region is then correspondingly angled, for example in an S-shaped manner, to match the central limb of the first border region. When the two elements are arranged in contact with each other, the second border region, for example angled in an S-shaped manner, is placed against the central limb of the U-profile of the first border region, so that the outer sections of the two border regions again lie essentially in a common plane and extend away from each other. As a result, the connecting element can laterally enclose the two border regions respectively in order thereby to ensure that the two elements are connected to each other.

The first border region and the second border region can be formed either along a vertical longitudinal edge or along an essentially horizontal longitudinal edge of the corresponding elements. Irrespective of a horizontal or vertical profile of the respective border regions, a space-saving sliding-on or pushing of the connecting element onto the two border regions is possible as a result.

In an advantageous development of the invention, the connecting element can be designed along its longitudinal axis as an essentially closed U-profile with an open central region. When the connecting element is slid or pushed onto the first border region and the second border region, the first element and the second element extend through the open central region. The length of the central limb of the connecting element perpendicular to the longitudinal axis of the connecting element is advantageously matched to the distance of the respective outer edges of the first and second border regions from each other. This ensures a desired clamping or bracing of the two border regions with respect to each other.

The bracing of the first border region and of the second border region when the connecting element is slid or pushed on is assisted in particular by the outer sections of the two border regions tapering conically to each other. The connecting element is likewise of conical design to match the conical profile of the two border regions and therefore braces the two border regions with respect to each other.

In an advantageous development of the invention, the connecting element can additionally be provided, for example on its end side or face side, with screwing means which are provided essentially parallel to the longitudinal axis of the connecting element. The screwing means can be brought into engagement with a flange or the like of the first plate element and of the second plate element, as a result of which, in particular in the case of a conical profile of the two border regions and of the connecting element, the bracing of the two border regions with respect to each other is promoted. The bracing keeps the connecting element in position relative to the two border regions in a secure manner during use, even if vibration or the like occurs.

Further advantages and configurations of the invention emerge from the description and the accompanying drawing.

It goes without saying that the features mentioned above and those which have yet to be explained below can be used not only in the respectively stated combination, but also in other combinations or on their own without departing from the framework of the present invention.

### BRIEF DESCRIPTION OF THE DRAWINGS

The invention is illustrated diagrammatically using an exemplary embodiment in the drawings and is described in detail below with reference to the drawings.

FIG. 1 shows a perspective view of the arrangement according to the invention with a cross member secured on longitudinal members of a vehicle.

FIG. 2 shows a plan view of a first element and a second element of the arrangement according to the invention.

FIG. 3 shows a connecting element of the arrangement, which laterally encloses border regions of the first and of the second element.

FIG. 4 shows a plan view of the arrangement with the connecting element pushed on.

FIG. 5 shows a plan view of the border regions of the first and of the second element in a further embodiment.

FIG. 6 shows a side view of the arrangement.

FIG. 7 shows a lateral cross-sectional view of the arrangement.

FIG. 8 shows, in an enlargement, the detail A of FIG. 6.

FIG. 9 shows a front view of the arrangement.

FIG. 10 shows a perspective view of the arrangement.

### DETAILED DESCRIPTION OF THE PREFERRED EMBODIMENT

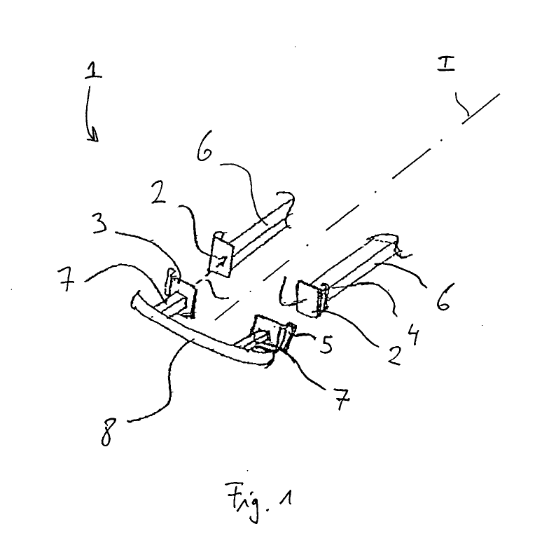

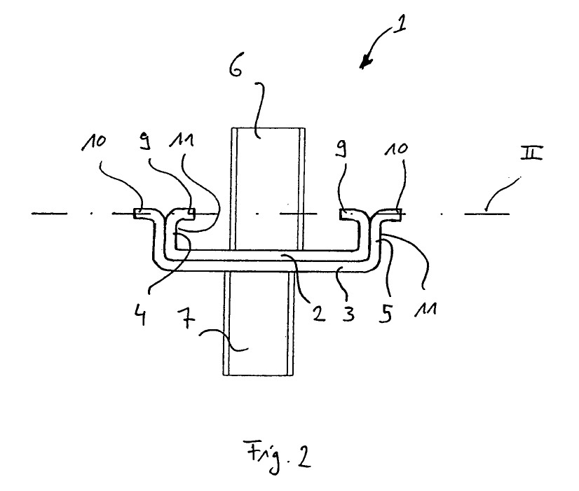

FIG. 1 shows an arrangement 1 according to the invention for securing a cross member in the form of a bumper on longitudinal members of a motor vehicle. The arrangement 1 comprises a first element 2 and a second element 3. The first element 2 and the second element 3 respectively have an angled first border region 4 and an angled second border region 5 along their vertical longitudinal edges (only illustrated on one longitudinal edge in FIG. 1). The border regions 4, 5 are matched in terms of their angling to each other in such a manner that the two elements 2, 3, when in a contact arrangement, can be connected to each other by a connecting element. This is explained in detail below in FIGS. 2 to 4.

The first element 2 is designed in the form of a plate and is in each case fitted on an end side of a longitudinal member 6 of a vehicle (not shown). In the same manner, the second element 3 is designed in the form of a plate and is secured in each case on webs 7 of the cross member 8. The securing of the respective second elements 3 on the webs 7 of the cross member 8 is configured in such a manner that the second elements 3 are situated opposite the first elements 2, which are fitted on the longitudinal members 6.

The configuration of the border regions of the first and second elements 2, 3 is explained in detail below with reference to FIGS. 2 to 4.

FIG. 2 shows a plan view of the first element 2 and the second element 3. A central region of the respective elements 2, 3 is secured on an end side of the longitudinal member 6 or of the web 7, respectively. On the left and right vertical longitudinal edges of the first element, the first border region 4 is formed in the shape of a U-profile, with a central limb 11 of the U-profile extending away from the opposite, second element 3. In the case of the second element 3, the respective second border regions 5 on the left and right vertical longitudinal edges are angled in an S-shaped manner to match the respective central limb 11. The outer section 9 of the first border region 4 and the outer section 10 of the second border region 5 extend essentially away from each other and essentially in a common plane II.

With the embodiment of the arrangement 1 that is shown in FIG. 2, it is possible to move the cross member 8 essentially parallel to the longitudinal axis I of the vehicle in the direction of the longitudinal member 6 in order to bring the plate elements 2, 3 into a contact with each other, as shown in FIG. 2.

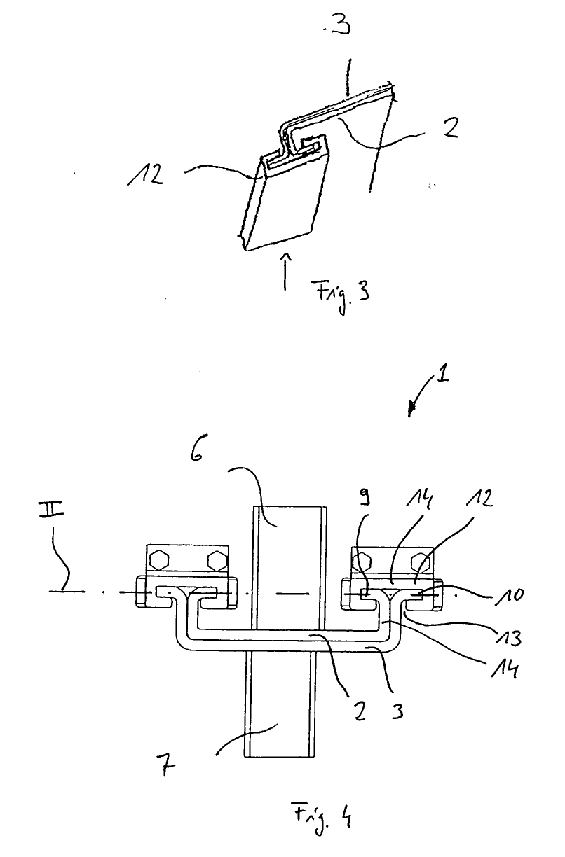

In the contact arrangement of the first plate element 2 with the second plate element 3, a connecting element 12 can be pushed onto the first border region 4 and the second border region 5, so that the connecting element 12 laterally encloses the outer sections 9, 10 of the first border region 4 and of the second border region 5, respectively. FIG. 3 shows, in a perspective view, the connecting element 12 in the pushed-on state. The connecting element 12 can be pushed from a direction from below onto the two border regions 4, 5, for example as indicated by an arrow. Because of this difference between the direction of joining the cross member and the longitudinal member and the direction of fixation and the thereby effected improved accessibility, a significant advantage over conventional methods and systems of securing a cross member to a vehicle is achieved.

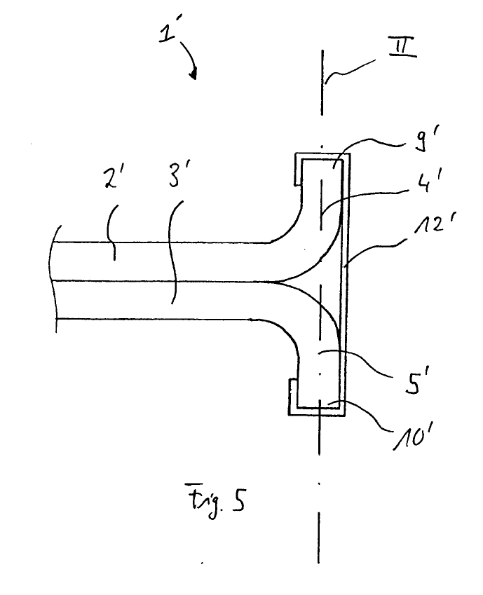

The plan view of FIG. 4 shows the arrangement 1 of FIG. 2 with the connecting element 12 now pushed on. It can clearly be seen that the connecting element is designed as an essentially closed U-profile with an open central region 13. In the pushed-on state, the first element 2 and the second element 3 can thus extend through the open central region 13. The length of a central limb 14 of the U-profile 12 perpendicular to its longitudinal axis is matched to the distance between the respective outer edges of the outer sections 9, 10. It is thereby ensured, when the U-profile 12 is pushed onto the first and second edge regions 4, 5, that the first element 2 and the second element 3 are kept together in a contact arrangement. The U-profile 12 thus ensures that the two elements 2, 3 are secured on each other and that the cross member 8 is secured on the longitudinal members 6 of the vehicle without the use of conventional screws, stud bolts or the like which are usually provided on the end sides of the plate elements 2, 3.

FIG. 5 shows a plan view of the first and of the second element 2′, 3′ of the arrangement 1′ in an alternative embodiment. In this case, the first border region 4′ and the second border region 5′ are angled such that they face away from the respective other, opposite element 2′, 3′, with the outer sections 9′, 10′ of the first border region 4′ and of the second border region 5′, respectively, also extending away from each other and essentially in the common plane II. In the same manner as explained with reference to FIGS. 3 and 4, the U-profile 12′ can therefore be pushed onto the first and second border regions 4′, 5′, so that, as a result of the U-profile 12′ laterally enclosing the outer sections 9′, 10′ of the two border regions 4′, 5′, the two elements 2′, 3′ are secured on each other.

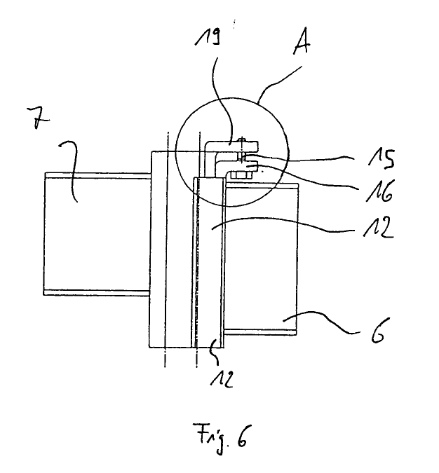

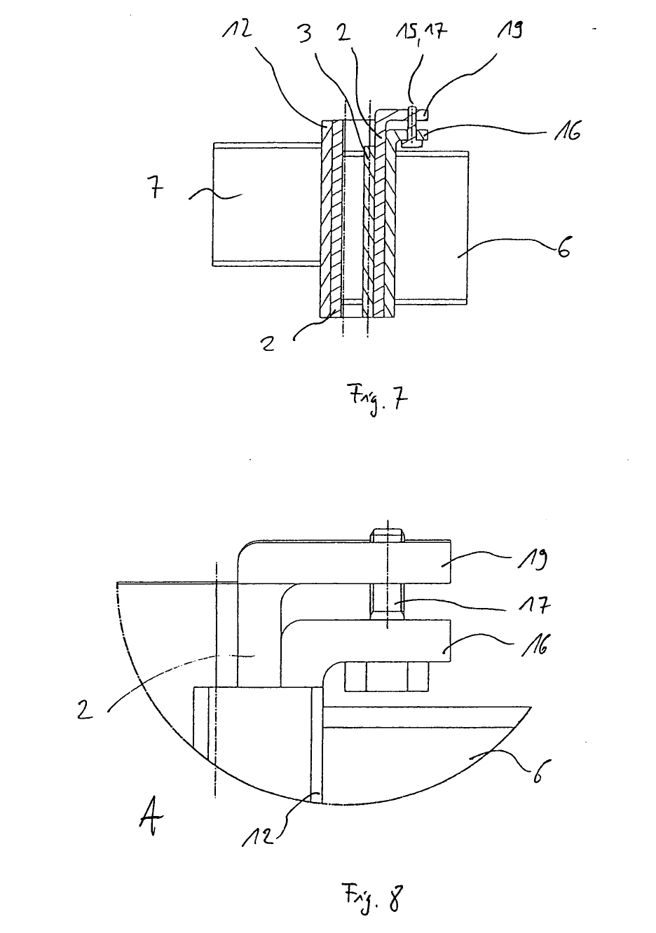

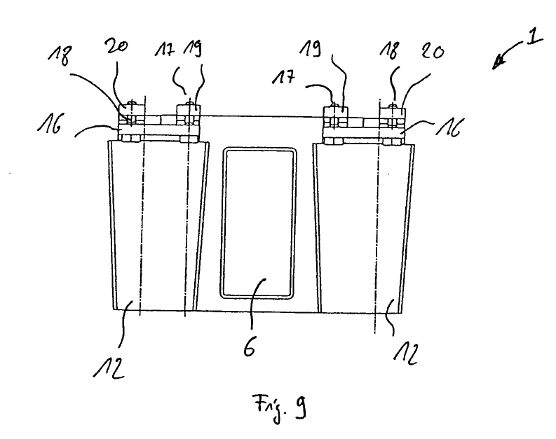

Referring to FIGS. 6-10, for a secure fixing of the U-profile 12 relative to the two border regions 4, 5, the U-profile 12 is provided with screwing means 15 on an end side/face side. For this purpose, the U-profile 12 has, on its face side, a flange 16 which is angled at right angles and in which the screwing means are accommodated essentially parallel to the longitudinal axis of the U-profile 12. In particular, the screwing means 15 comprise a first machine screw 17 and a second machine screw 18 which are in each case guided from below through corresponding through holes formed in the flange 16.

Fitted on an upper side of the first element 2 and of the second element 3 are a further flange 19 and a further flange 20 which are angled at right angles in the same manner as the flange 16 and extend essentially parallel to the latter. Respective threaded bores (not shown) which are matched to the machine screws 17 and 18 are formed in the flanges 19, 20. When the U-profile 12 is entirely pushed onto the first and second border regions 4, 5, the machine screws 17, 18 can be screwed into the threaded bores of the flanges 19, 20, so that the position of the U-profile 12 relative to the two border regions 4, 5 is fixed.

FIGS. 6 to 8 show the U-profile in a completely pushed-on state, with the machine screws 17, 18 being in engagement with the threaded bores 19, 20. As a result, a release of the U-profile from the two border regions is effectively prevented. It goes without saying that, in the side views of FIGS. 6 to 8, of the two flanges 19 and 20 only the one being situated at the front in the plane of the drawing is shown, i.e., for example, the flange 19 fitted on the first element 2.

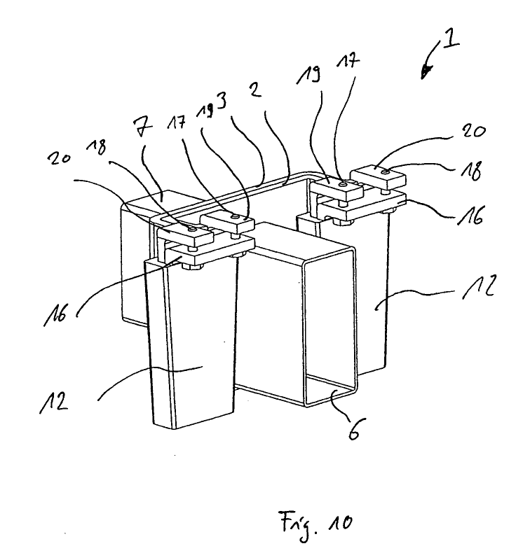

For a further improved securing of the two elements 2, 3 onto each other, the outer sections 9, 10 of the first border region 4 and of the second border region 5 can taper conically to each other, as is shown in the front view of FIG. 9. In accordance therewith, the U-profile 12 is likewise of conical design along its longitudinal axis, so that an inner surface of the U-profile is positioned against the respective outer sections 9, 10. When the conically designed U-profile 12 is pushed onto the border regions 4, 5 running conically to each other, a tightening of the two machine screws 17, 18 enables a bracing of the U-profile 12 against the two border regions 4, 5 to be obtained. This bracing ensures that, when used in motor vehicles, the U-profile 12 is not released even as a consequence of severe vibrations, shaking movements or the like, so that, as a result, the cross member 8 is safely secured on the longitudinal members 6.

To further illustrate the conicity of the two border regions 4, 5 and of the U-profile 12, the arrangement 1 according to the invention is shown in FIG. 10 in a perspective side view. It can clearly be seen that the flange 16 of the U-profile 12 can be drawn by means of the screws 17, 18 in the direction of the flanges 19, 20 of the first element 2 and of the second element 3, as a result of which the bracing of the U-profile 12 by the two border regions 4, 5 is obtained.

In the case of the embodiment shown in FIG. 10, the U-profile 12 is pushed onto the two border regions 4, 5 (in each case indicated by arrows) from a lower side of the longitudinal members 6. This is of great advantage during an installation of the cross member 8 on the longitudinal members 6 in so far as sufficient space is available from the lower side of the longitudinal member 6 for pushing on the U-profile 12. Finally, this advantage is achieved by the difference between the direction of joining the cross member and the longitudinal member and the direction of fixation. As an alternative to the embodiment shown in FIG. 10, the two border regions 4, 5 on the first and second elements 2, 3, respectively, may also be provided rotated through 90°, i.e. in each case on a horizontal longitudinal edge of the elements 2, 3. The U-profile 12 can then correspondingly be pushed onto the two border regions 4, 5 from one side of the longitudinal member 6, which can likewise readily be carried out during an installation of the cross member 8 on the longitudinal members 6.

In comparison to a conventional means of securing a cross member on longitudinal members of a vehicle, the arrangement 1 according to the invention affords the advantage of a simplified and space-saving securing possibility without the use of conventional screwing means provided on the end side. Further, the connecting arrangement allows a non-destructive detachment of the cross member in case the cross member was damaged, e.g. in a car accident.

What is claimed is:

1. An arrangement for connecting two elements, comprising:
a first element which has an angled first border region at least along one longitudinal edge,
a second element which has an angled second border region at least along one longitudinal edge, wherein, when the two elements are arranged in contact with one another, outer sections of the first border region and of the second border region extend away from one another and essentially in a common plane; and
a connecting element which, when the two elements are arranged in contact with one another, laterally encloses the first border region and the second border region, respectively.

2. An arrangement according to claim 1, in which the first border region and the second border region are angled such that they face away from the respective other, opposite element.

3. An arrangement according to claim 2, in which the first border region and the second border region, respectively, are angled at right angles.

4. An arrangement according to claim 1, in which the first border region is formed essentially in the shape of a U-profile, the central limb of which extends away from the opposite, second element, with the second border region being angled, in particular in an S-shaped manner, to match the central limb of the first border region.

5. An arrangement according to claim 4, in which the first border region and the second border region run essentially vertically or essentially horizontally.

6. An arrangement according to claim 5, in which the connecting element is designed along its longitudinal axis as a closed U-profile with an open central region through which the first element and the second element extend, the length of the central limb of the connecting element perpendicular to the longitudinal axis of the connecting element being matched to the distance of the respective outer sections of the first and second border regions from each other.

7. An arrangement according to claim 6, in which the outer sections of the first border region and of the second border region taper conically to each other, the connecting element being designed to match the conical profile of the two outer sections and bracing the two border regions with respect to each other.

8. An arrangement according to claim 7, in which a face side of the connecting element is provided with screwing means which are arranged essentially parallel to the longitudinal axis of the connecting element and are respectively in engagement with a flange of the first element and with a flange of the second element.

9. An arrangement according to claim 8, in which the screwing means in engagement with the respective flanges of the first element and of the second element brace the border regions of the elements with respect to each other.

10. An arrangement according to claim 9, in which the first element and the second element are each designed in the form of a plate element, with it being possible to bring the plate elements into a contact arrangement.

11. An arrangement according to claim 10, in which the first element and the second element respectively have the angled first border region and the angled second border region on opposite longitudinal edges.

12. An arrangement according to claim 11 for securing a cross member on at least one longitudinal member of a motor vehicle, in which the first element is fitted essentially vertically on an end side of a longitudinal member, and in which the second element is fitted essentially vertically on the cross member, so that the two elements can be secured essentially vertically onto each other.

13. An arrangement according to claim 12, in which the connecting element can be pushed from a lower side of the longitudinal member onto the first border region and onto the second border region.

14. An arrangement according to claim 13, in which the connecting element can be pushed from one side of the longitudinal member onto the first border region and onto the second border region.
